(19) United States
(12) Patent Application Publication
(10) Pub. No.: US 2014/0270996 A1
(43) Pub. Date: Sep. 18, 2014

(54) LID ASSEMBLY FOR A VACUUM RECEIVER VESSEL

(71) Applicant: Charles W. Thiele, Kalamazoo, MI (US)

(72) Inventor: Charles W. Thiele, Kalamazoo, MI (US)

(21) Appl. No.: 13/804,828

(22) Filed: Mar. 14, 2013

(51) Int. Cl. B65G 53/40

(52) U.S. Cl. CPC B65G 53/40
USPC 406/122

(57) ABSTRACT

A lid for the receiver vessel an centrally disposed intake opening and a plurality of outlet openings located on diametrically opposite sides of the intake opening, a non-perforated pipe of finite length connected to the intake opening and extending a finite distance that is at a minimum 2.5 times the diameter of the non-perforated pipe into the receiver vessel, the relationship of the diameter of the non-perforated pipe and the inside diameter of the receiver vessel which defines an air space therebetween being configured to a ratio that is equal to or greater than 1:2.5 to thereby cause the gas/air flow through the air space toward the plural outlet openings to be substantially uniform and substantially less than a pick-up velocity of the particulate so as to cause the particulate to become separated from the air flow.

### FIELD OF THE INVENTION

This invention relates to an assembly for separating air entrained particulate from an air stream in a pipe and, more particularly, to a lid assembly for a vacuum receiver vessel having a central intake opening and a non-perforated pipe of a finite diameter extending into the central portion of the receiver vessel a finite distance, the air space between the outer diameter of the non-perforated pipe and the inside diameter of the receiver vessel and plural outlet openings being configured to limit the air speed of the volume of air moving therethrough to the plural air outlet openings in the lid located circumferentially generally equidistantly spaced from the intake opening and each other to less than a pick-up velocity of the particulate.

### BACKGROUND OF THE INVENTION

In the plastics industry, processors use a vacuum system to convey a product to a vacuum receiver which is located on the extruder or molding machine. A screen or filter is used to separate the incoming material from the air steam as the air and material flows to a vacuum Blower. The product is may be a virgin (pelleted) material, regrind (ground plastic, powder or a combination of some or all. During the conveying cycle, the screen or filter on the vacuum receiver will become clogged, creating an increase in the pressure drop of the system. The increase in pressure drop causes a loss in conveying efficiency. In order to rectify the problem, it then becomes necessary to add a special screen or filter and cleaning system which will automatically clean the filter or screen after each filling cycle. The cleaning system usually uses blasts of compressed air to clean the filter/screen, often creating dust problems as dust escapes from the vessel, into the atmosphere.

In the aforesaid situations, a mixture of materials or selected materials enters the vacuum receiving vessel through a radial or tangential inlet in the hopper body. The screen/filter and cleaning assembly is located in the cover for the vessel.

Accordingly, it is an object of the invention to provide a filter-less cover assembly embodying the invention which eliminates the need for the filter/screen, the filter cleaning systems, dust problems and losses in conveying efficiency due to increased pressure drop.

It is a further object of the invention to provide a filter-less cover assembly as aforesaid which is designed to be simply substituted for the existing cover assembly having thereon the filter or screen equipment as well as the cleaning system therefor.

### SUMMARY OF THE INVENTION

The objects and purposes of the invention are met by providing on a lid for the receiver vessel an centrally disposed intake opening and plural outlet openings located circumferentially generally equidistantly spaced around the central intake opening and from each other, a non-perforated pipe of finite length connected to the intake opening and extending a finite distance that is at a minimum 2.5 times the diameter of the non-perforated pipe into the receiver vessel, the relationship of the diameter of the non-perforated pipe and the inside diameter of the receiver vessel which defines an air space therebetween being configured to a ratio that is equal to or greater than 1:2.5 to thereby cause the air flow through the air space toward the plural outlet openings to be to be substantially uniform and substantially less than a pick-up velocity of the particulate so as to cause the particulate to become separated from the air flow.

### BRIEF DESCRIPTION OF THE DRAWINGS

Other objects and purposes of the invention will be apparent to persons acquainted with apparatus of this general type upon reading the following specification and inspecting the accompanying drawings, in which:

FIG. 1 is a schematic central cross-sectional view of a vacuum receiver lid assembly embodying my new invention mounted on a receiver vessel associated with a material hopper for collecting the particulate that has been separated from the gas (air) flow as well as a vacuum blower assembly;

FIG. 2 is a central cross-sectional view of the lid assembly per se;

FIG. 3 is a top view of the lid assembly; and

FIG. 4 is a chart listing sample particulate pick-up velocities and sample receiver vessel diameters.

### DETAILED DESCRIPTION

Certain terminology may be used in the following description for convenience and reference only and will not be limited. The words “up” and “down” will designate direction in the drawings to which reference is made. The words “upstream” and “downstream” will refer to the direction of material flow through the device, “upstream” to “downstream” being the normal flow direction. The words “in” and “out” will refer to directions toward and away from, respectively, the geometric center of the device and designated parts thereof. The words “gas”, “air”, “gas flow” and “airflow” will be used interchangeably and are not to be limiting. Such terminology will include the words above specifically mentioned, derivatives thereof and words of similar import.

While the following discussion does not refer to the use of the device in conjunction with any specific type of equipment, it is to be understood that its application is broad based and can be applied in any type of vacuum system, continuous or intermittent, to provide the filling of a variety of extruders, injection molding machines, storage silos, mixers, and virtually any other receiving vessel or device to which the particulate material would have to be conveyed.

The subject matter of my earlier issued U.S. Pat. Nos. 4,583,885, 5,776,217 and 6,251,152 are incorporated herein by reference. Environments into which this invention can be utilized are disclosed in my earlier issued U.S. Pat. No. 5,622,457 and the subject matter of this patent is to be incorporated by reference as well. In addition, a device for effecting the entrainment of particles into a gas stream is disclosed in my earlier issued U.S. Pat. No. 5,340,241 and the subject matter of this patent is to be incorporated herein by reference as well.

As a quick overview of this disclosure, FIG. 1 illustrates a vacuum receiver 10 adapted to separate a particulate material or particles P entrained in a gas-particle stream S from a particulate material source 11. The particles at the source 11 are entrained into a gas-particle stream S by, for example, a pneumatic vacuum conveying system as shown in U.S. Pat. Nos. 4,583,885, 5,340,241 and 5,490,745, this latter patent being additionally incorporated by reference. As shown in FIG. 1, the vacuum blower 12 creates a gas flow within a gas tight gas flow system represented in FIG. 1 by drawing gas into the inlet end of an inlet pipe 13, and through an interior of the vacuum receiver 10 and thence through dual gas outlet pipes 14 and a manifold 16 which joins the dual outlet pipes 14 into a single pip 17.

FIGS. 1 and 2 both illustrate my unique lid or cover assembly 20 for a receiver vessel 21 part of the vacuum receiver 10. The lid 20 is comprised of a flat plate 22 having a central opening 23 therethrough and a plurality of other through-openings 24 oriented circumferentially generally equidistantly spaced around the central opening 23 and from each other. In this particular embodiment, there are two other through-openings 24, although it is to be recognized that more than two other through-openings 24 can be provided and be within the scope of the invention. When there is an even number of other through-openings 24, a pair or pairs of the other through-openings are located generally equidistantly spaced from and on diametrically opposite sides of the central opening. The inlet pipe 13 is composed of two solid, non-perforated sections 26 and 27 having a right angle elbow construction 28 oriented between the two sections 26 and 27. The section 27 of the inlet pipe is configured to be rotatably mounted in a bearing 29 and extend through the central opening 23. The bearing 29 also is configured to prevent air from being sucked into the interior of the receiver vessel 21. One end of the elbow construction between the two sections 26 and 27 is connected being connected to one end, here, the upper end of the section 27 and is configured to provide a flat abutment surface 31, the plane of which is oriented either parallel to the longitudinal axis of the section 27 or, and preferably, inclined slightly away from the longitudinal axis of the of the section 27 as shown in FIGS. 1 and 2 so as to define a chamber 32. The section 26 is connected to the other end of the elbow construction upstream of the chamber 32 and extends to a terminal end whereat gas (air) can enter the open inlet end 33.

The vacuum receiver 10 includes a hollow interior hopper or vessel 34. The vessel includes a cylindrical shell 36 mounted on a base 37 defining a funnel-like structure leading to an outlet opening 38. A discharge valve 39 is provided in the outlet opening 38 and is rotatable between open and closed positions in relationship to the outlet opening 38, the closed position being illustrated. The discharge valve 39 is configured to maintain a vacuum tight seal at the bottom of the hopper 37 at all times. The discharge valve 39 may also be a rotating sluice type valve which will maintain the vacuum tight seal while continuously discharging the particulate P. In this particular embodiment, the cylindrical shell 36 is welded together with the upper end of the conical section 37 with a bottom flange 41 being provided at the lower end of the hopper being bolted to a mating flange 42 on the discharge valve 39. The inner diameter D1 of the vacuum receiver cylinder 36 is at a minimum 2.5 times the outer diameter D2 of the non-perforated pipe section 27. The non-perforated pipe section 27 has a length L is at a minimum of 2.5 times the outer diameter D2 of the non-perforated pipe section 27. An annular air space 35 is provided between the outer diameter D1 of the pipe section 27 and inner diameter D2 of the vessel 36.

In this particular embodiment, the lid 20 is designed to be a removable lid which is tightly mounted onto the open top part of the vessel 36 for form a seal thereat. A conventional rubber-like seal (not shown) is provided between the upper end of the vessel 36 and the lid 20. The outside of the upper end of the vessel 36 has plural protrusions 43 thereon. Conventional clips 44 operatively engage the protrusions 43 to affix the lid 20 to the upper end of the vessel 36 and compress the material of the rubber-like seal. It is to be recognized that a lid configuration that is welded or otherwise permanently affixed to the open top vessel 36 is to be considered within the scope of this invention.

FIG. 2 illustrates the lid 20 independent of the receiver vessel 36. FIG. 3 illustrates a top view of the lid 20, the arrow 46 indicating the ability of the pipe section 26 to swivel about the axis of the central opening 23 due to the support provided by the bearing 29.

### Operation

Although the operation of the vacuum receiver described above will be understood from the foregoing description by skilled persons, a summary of such description is now given for convenience.

When the suction blower 12 is activated, airflow of sufficient volume and velocity is drawing into the inlet end 33 of the pipe section 26 to pick up and convey the material P and entrain it in the airflow. The flow of the gas (or air) S and material P passes through the pipe section 26 to the elbow construction 28 and the kinetic energy of the material P causes it to impact against the abutment surface 31 to reduce the kinetic energy of the material prior to it entering the upper end of the pipe section 27. The following material P impacts against the collected material in the chamber 32 to thus prevent any abrasive wear on the abutment surface 31. The material and airflow enters the vessel 36 whereat the airflow undergoes a 180 degree turn into the air space 35 and the kinetic energy of the material causes it to me separated from the airflow and collect in the hopper 37. The velocity of the gas S entering the air space 35, the length of which is 2.5 time the outer diameter D2 of the pipe section 27, is less than 10% of the minimum velocity required to convey the material P. This low velocity is assured by maintaining the ratio of the outer diameter D2 of the pipe section 27 and the inner diameter D1 cylinder 17 at a minimum of 1:2.5 and by the orientation of the plural second through-openings 24 in the lid.

The chart illustrated in FIG. 4 shows the pick-up velocity of various materials and dimensions of the outer diameter D2 of the pipe section 27 and inner diameter D1 if of the receiving vessel 36 in order to achieve the aforesaid gas velocity that is less than 10% of the pick-up velocity of the particulate.

The conveying gas S exits the vacuum receiver 10 through two (or more) circumferentially and generally equidistantly spaced pipes 14 surrounding the central opening 23 to create a uniform upward velocity in the air space 35 which is less than 10% of the minimum velocity required to convey the particulate P to cause the material to settle into the hopper 37. No material is able to reach the outlet pipes 14.

For servicing the vacuum receiver as disclosed herein and with the suction blower means 12 rendered inactive, the machine operator need only to release the clips 44 and lift off the entire cover 20 thus providing immediate access to the entire interior of the vacuum receiver and the underside of the cover 20. In addition, the pipe section 27 can at that be changed to a different diameter to achieve a different operation characteristic on the material.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A lid for use on an open top, circular cross-sectioned, vacuum receiver vessel for collecting a particulate having a mass, the vacuum receiver vessel having a first inside diameter, comprising:
a centrally oriented first through-opening in said lid;
a gas/air and gas/air entrained particulate intake pipe connected to communicate with said first through-opening, said intake pipe including a particulate kinetic energy reduction surface oriented immediately above said centrally oriented first through-opening, a centrally disposed non-perforated cylindrical pipe connected to and extending away from said lid on a side of said lid that is remote from said intake pipe and said particulate kinetic energy reduction surface and into the open top of the receiver vessel a finite distance that is a minimum of 2.5 times an outer diameter of said non-perforated pipe, said outer diameter of said cylindrical pipe being selected so that the relationship of said outer diameter of said cylindrical pipe and an inside diameter of the vacuum receiver vessel onto which said lid is being fastened has a ratio that is equal to or greater than 1:2.5;
a plurality of second through-openings in said lid that are oriented circumferentially generally equidistantly spaced around said first through-opening and generally equidistantly spaced from a center of said first through-opening and specifically configured to cause a uniform volume of gas/air to flow inside the receiver vessel through a gas/air space between said outer diameter of said cylindrical pipe and an inside diameter of the vacuum receiver vessel and toward said second through-openings, a velocity of the volume of gas/air being insufficient to keep the particulate entrained in the gas/air flow; and
a gas/air outlet pipe connected to communicate with each of said second through-openings, said outlet pipes being connected together at a manifold to form a single air outlet pipe configured to be connected to a vacuum source;
whereby when the vacuum source is activated, gas/air and gas/air entrained particulate will, after the velocity of the gas/air entrained particulate has been decelerated by the particulate deceleration surface, be drawn into the vacuum receiver vessel through said non-perforated cylindrical pipe and as the gas/air and gas/air entrained particulate exit said non-perforated cylindrical pipe, the gas/air will be uniformly drawn into the aforesaid air space between said outside diameter of said non-perforated cylindrical pipe and said inside diameter of said vacuum receiver vessel to exit the vacuum receiver vessel through said second through-openings in said lid whereas the kinetic energy component of the particulate will cause the particulate to become dissociated from the gas/air flow and since the gas/air flow in the aforesaid air space is at a velocity that is below a pick-up velocity of the particulate, the particulate will be caused to be deposited, due to an influence of gravity on the particulate, into the vacuum receiver vessel.

2. The lid for use on an open top, circular cross-sectioned, vacuum receiver vessel according to claim 1, wherein said ratio of the outer diameter of the non-perforated pipe inside the receiver vessel to the inner diameter of the receiver vessel is configured to keep the velocity of the gas/air flowing through the air space at less than 10% of the pick-up velocity of the particulate.

3. The lid for use on an open top, circular cross-sectioned, vacuum receiver vessel according to claim 1, wherein said plurality of second through-openings are two in number.

4. The lid for use on an open-top, circular cross-sectioned, vacuum receiver vessel according to claim 1, wherein said intake pipe is configured to rotate relative to said lid on an axis that is coextensive with an axis of said non-perforated cylindrical pipe.

5. The lid for use on an open top, circular cross-sectioned, vacuum receiver vessel according to claim 1, wherein an even number of second through-openings are provided on said lid, a pair of said second through-openings being oriented on diametrically opposite sides of said first through-opening.

6. The lid for use on an open top, circular cross-sectioned, vacuum receiver according to claim 1, wherein said lid is configured to be removable from the open top vacuum receiver vessel and includes fastening means for facilitating a releasable fastening of the lid to the open top vacuum receiver vessel.

7. A lid for use on an open top, circular cross-sectioned, vacuum receiver vessel for collecting a particulate having a mass, the vacuum receiver vessel having a first inside diameter, comprising:
a centrally oriented first through-opening in said lid;
a gas/air and gas/air entrained particulate intake pipe connected to communicate with said first through-opening, said intake pipe including a particulate kinetic energy reduction surface oriented immediately above said centrally oriented first through-opening, a centrally disposed non-perforated cylindrical pipe connected to and extending away from said lid on a side of said lid that is remote from said intake pipe and said particulate kinetic energy reduction surface and into the open top of the receiver vessel a finite distance that is a minimum of 2.5 times an outer diameter of said non-perforated pipe, said outer diameter of said cylindrical pipe being selected so that the relationship of said outer diameter of said cylindrical pipe and an inside diameter of the vacuum receiver vessel onto which said lid is being fastened has a ratio that is equal to or greater than 1:2.5; and
a plurality of second through-openings in said lid that are located with respect to each other and with respect to said first through-opening to produce a uniform gas/air flow through a gas/air space between said outer diameter of said cylindrical pipe and an inside diameter of the vacuum receiver vessel and toward said second through-openings that is less than 10% of the pick-up velocity of particulate.
